(19) United States
(12) Patent Application Publication
(10) Pub. No.: US 2007/0005375 A1
(43) Pub. Date: Jan. 4, 2007

(54) Method of retailing and associated interactive retail store environment

(75) Inventor: Daniel J. Lauer, St. Louis, MO (US)

Correspondence Address: Thomas A. Polcyn;Thompson Coburn LLP, One US Bank Plaza, St. Louis, MO, 63101, US

(73) Assignee: Lauer Toys Incorporated

(21) Appl. No.: 11/147,834

(22) Filed: Jun. 8, 2005

(51) Int. Cl. G06Q 99/00

(52) U.S. Cl. 705/1

(57) ABSTRACT

A method of retailing comprises the steps of: providing a retail store environment configured to simulate a maternity hospital with a simulated baby delivery area; providing an on site inventory of dolls resembling human babies available for sale; providing a retail store customer with an opportunity to select desired doll characteristics; and delivering to the customer, in the simulated baby delivery area, a doll having such desired doll characteristics.

### FIELD OF THE INVENTION

The present invention relates to the sale of dolls. More particularly, the present invention relates to a novel retail store environment configured to simulate a maternity care hospital and methods for retailing dolls (such as newborn infant dolls that exhibit life-like characteristics), and other associated merchandise, in a simulated maternity care hospital setting.

### BACKGROUND OF THE INVENTION

The history of dolls reaches back tens of thousands of years. While history suggests that early dolls may have been worshipped as objects thought to have magical powers, or as embodiments of spirits or other symbols to be worshipped, once these symbolic or religious roles of dolls became less significant, dolls became toys for children. Playing with dolls is stimulating, enjoyable and educational for young children.

The prior art contains dolls of all kinds, including those intended to resemble human infants. Young children desire to use dolls that are realistic and which simulate characteristics of live infants. Many prior art dolls have moveable parts or semi-compressible structures, but lack life-like feel, mobility, flexibility and structure.

Therefore, to enhance the joy and stimulation of young children who play such dolls, the inventor herein developed a novel, life-like infant doll, which is realistic in feel, compressibility, flexibility and structure. The doll is described in detail in co-owned U.S. Pat. No. 5,224,863, which is incorporated herein by reference. The doll disclosed in U.S. Pat. No. 5,224,863 has a head formed of a relatively stiff but flexible vinyl rubber material that simulates the hard surface of an infant baby's head, but the remainder of the infant doll's body (i.e., the neck, the torso, the arms, and the legs) is constructed of a less rigid vinyl material that simulates the feel and compressibility of a newborn infant. The housing wall for the doll's neck, torso, arms, and legs creates a contiguous reservoir that is capable of being filled with a liquid medium, such as warm water. When a liquid is introduced into the reservoir, the neck, torso, arms, and legs of the doll are filled with the liquid, which causes the doll to take on characteristics of a real infant baby, such as feel, flexibility, compressibility, heft and body temperature. The inventor's water-filled doll has achieved enormous commercial success continuing to the date of the writing of this patent.

Infant dolls have been sold in a variety of retail environments, including toy stores, retail department stores, collector shops, specialty stores and, more recently, on-line. However, in each case, the dolls are “finished” and packaged for sale. Typically, they are stocked on store shelves or in display cases, or they are photographed for catalogs or online sales. While such mass retailing provides a quick and convenient way for customers to purchase finished dolls, it provides no opportunity for interactivity, creativity or control on the child's part, and may inhibit the creation of the child's emotional connection to the doll.

Thus, there is a need for an interactive retail experience that heightens the child's emotional connection to the doll, by giving the child an opportunity for interactivity, creativity and control in the creation (or “birth”) of the doll.

### SUMMARY OF THE INVENTION

In accordance with the present invention, novel methods are provided for retailing dolls resembling human babies, and novel retail store environments are provided for use in performing such methods.

In general, a method of the present invention for retailing dolls comprises the steps of: providing a retail store environment configured to simulate a maternity hospital with a simulated baby delivery area; providing an on site inventory of dolls resembling human babies available for sale; providing a retail store customer with an opportunity to select desired doll characteristics; and delivering to the customer, in the simulated baby delivery area, a doll having such desired doll characteristics.

In another aspect of the invention, a method of retailing dolls comprises the steps of: providing a retail store environment; providing an on site inventory of dolls resembling human babies, each of said dolls having a flexible body at least partially defining an interior volume; at least partially filling the interior volume of a selected one of said dolls with a liquid, on site proximate the retail environment; and delivering the selected doll to a customer on site.

In a further aspect of the invention, a retail store environment is configured to simulate a maternity hospital. The retail store environment comprises an inventory of dolls, an on site section of the retail store environment configured to simulate a hospital admitting area, an on site section of the retail store environment configured to simulate a baby delivery area, and a check-out center. The dolls resemble human babies, and at least some of the dolls are available for sale on site. The simulated hospital admitting area includes a display of information sufficient to allow a retail store customer to request a doll having customer-selected doll characteristics. The simulated baby delivery area is staffed by a retail store employee who delivers to the customer a doll having the customer-selected doll characteristics. The check-out center includes retail equipment adapted for processing the sale of the delivered doll to the customer.

In still another aspect of the invention, a retail store environment is configured to simulate a maternity hospital, and includes two or more of the following distinct store sections: a simulated hospital admitting area adapted to receive retail store customers and display a representative sampling of dolls resembling human babies available for sale on site; a simulated baby delivery area staffed by a retail store employee who delivers dolls to customers; a simulated post-delivery wellness center having physical examination apparatus adapted for performing simulated physical examinations of dolls; an identification center configured for distribution of identification devices that match customers with their dolls, said identification devices being provided in pairs, each pair having matching indicia; and a check-out center with retail transaction processing equipment adapted for processing sales of dolls to customers.

In yet another aspect of the invention, a method of retailing dolls comprises the steps of providing a retail store environment having an on site showroom configured to display merchandise, providing an on site inventory storage area configured for on site storage of an inventory of dolls resembling human babies, and providing an on site section configured to simulate a maternity hospital. The inventory storage area is separated from the showroom and simulated maternity hospital in a manner so that the inventory of dolls stored in the inventory storage area is not visible from the showroom or simulated maternity hospital. The method further comprises displaying representative samples of at least some of the inventory of dolls in the showroom. The representative samples of the dolls displayed in the showroom have a variety of available doll characteristics that distinguish the samples form one another, thereby enabling a customer viewing the display to observe the distinguishing doll characteristics and determine desired doll characteristics based on the samples displayed. Thus, a retail store employee can retrieve from the inventory storage area a doll having the customer-desired doll characteristics, and then deliver to the customer a doll having the customer-desired doll characteristics, in the simulated maternity hospital.

While the principal advantages and features of the present invention have been described above, a more complete and thorough understanding and appreciation of the invention may be attained by referring to the Figures and detailed description of the preferred embodiments, which follow.

### BRIEF DESCRIPTION OF THE DRAWINGS

The accompanying Figures, which are incorporated in and form a part of the specification, illustrate exemplary embodiments of the present invention and, together with the description, serve to explain the principles of the invention.

FIG. 1 is a flow chart illustrating general aspects of a method of retailing of the present invention;

FIG. 2 is a representative plan view of a retail store of the present invention;

FIG. 3 is an elevational view of the simulated hospital nursery of FIGS. 1 and 2;

FIG. 4 is an elevational view of the simulated admitting area of FIGS. 1 and 2;

FIG. 5 is an elevational view of the simulated delivery area of FIGS. 1 and 2;

FIG. 6 is an elevational view of the wellness center of FIGS. 1 and 2;

FIG. 7 is an elevational view of the identification center of FIGS. 1 and 2;

FIG. 8 is an elevational view of the waiting room area of FIGS. 1 and 2; and

FIG. 9 is an elevational view of the checkout areas of FIGS. 1 and 2.

Reference characters shown in these Figures correspond to reference characters used throughout the following detailed description of the preferred embodiments.

### DETAILED DESCRIPTION OF THE PREFERRED EMBODIMENTS

The present invention includes methods for providing an interactive retail experience that gives customers, primarily children, an opportunity for creativity and control in the creation (or “birth”) of their own doll, in a setting that simulates the real-world.

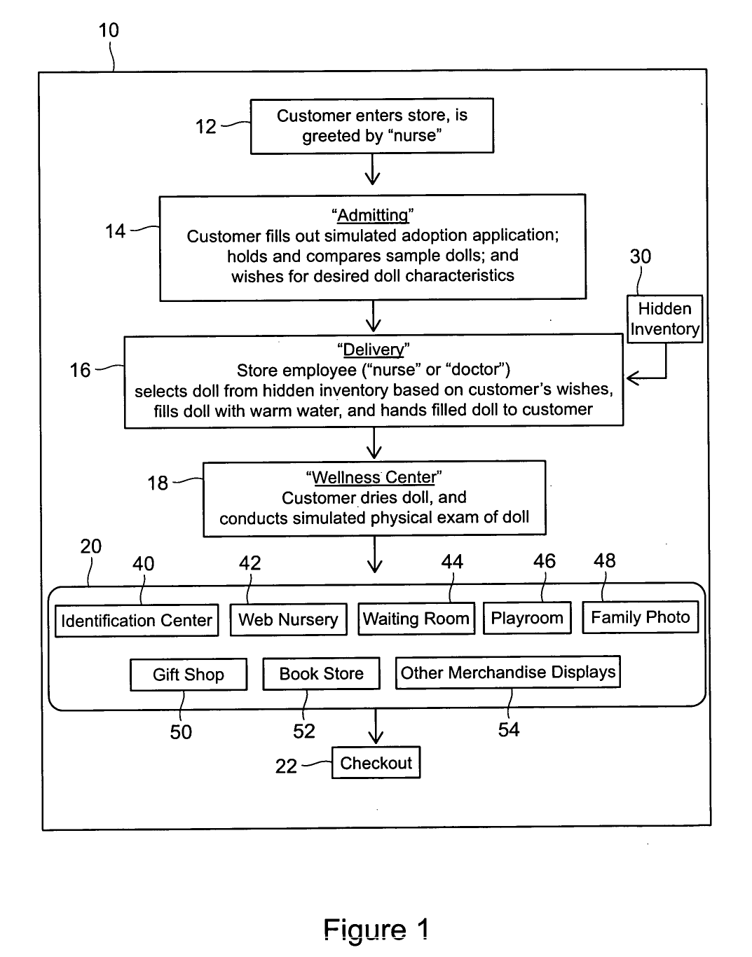

FIG. 1 is a flow chart illustrating certain general aspects of one such method of the present invention for providing an interactive retail experience. As shown in FIG. 1, and as explained in greater detail hereinafter, the method preferably includes providing a retail store environment 10 that is at least partially configured to simulate a maternity hospital; greeting customers upon entry into the store 12; directing customers to “Admitting” 14 where customers fill out a simulated adoption application and select desired doll characteristics; directing customers to “Delivery” 16 where a store representative delivers to the customer a doll having at least some of the customer's desired doll characteristics; directing the customer to a “Wellness Center” 18, where the customer can perform a simulated physical examination or check-up of his or her new doll; giving the customer an opportunity to go to one or more other areas of the store 20 that provide various activities and/or display accessories or other merchandise available for sale; and processing the customer's purchases at a checkout center 22.

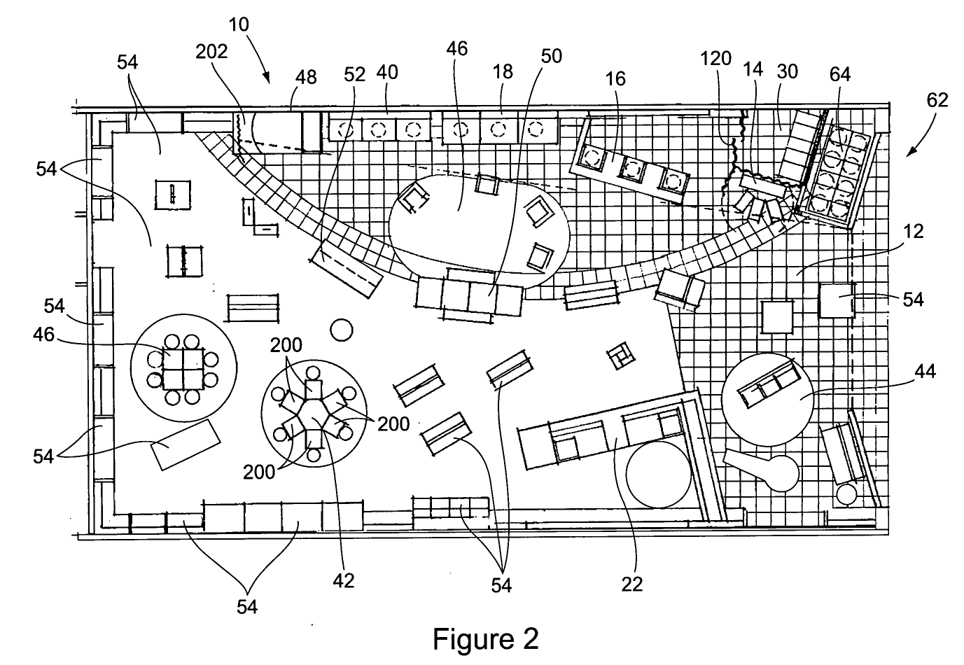

A floor plan for a preferred retail store environment of the present invention is illustrated in FIG. 2. Again, preferably, the retail store environment 10 is at least partially configured to simulate a maternity hospital. As shown in FIG. 2, in addition to the “Admitting” area 14, “Delivery” area 16, “Wellness Center” 18 and checkout center 22, the retail store environment 10 preferably includes one or more of the following store areas or stations: a hidden inventory 30 of dolls, an identification center 40, a web nursery 42, a waiting room 44, a playroom 46, a family photo center 48, a gift shop 50, a book store 52, and various other displays 54 with merchandise available for sale (e.g., doll clothing, doll furniture and other doll gear, “finished” dolls, seasonal products, etc.). Preferred embodiments of these are described in more detail hereafter, but it should be understood that the floor plan illustrated in FIG. 2 is one preferred floor plan, and that other layouts and store sections could be used in practicing the present invention, which is defined solely by the claims.

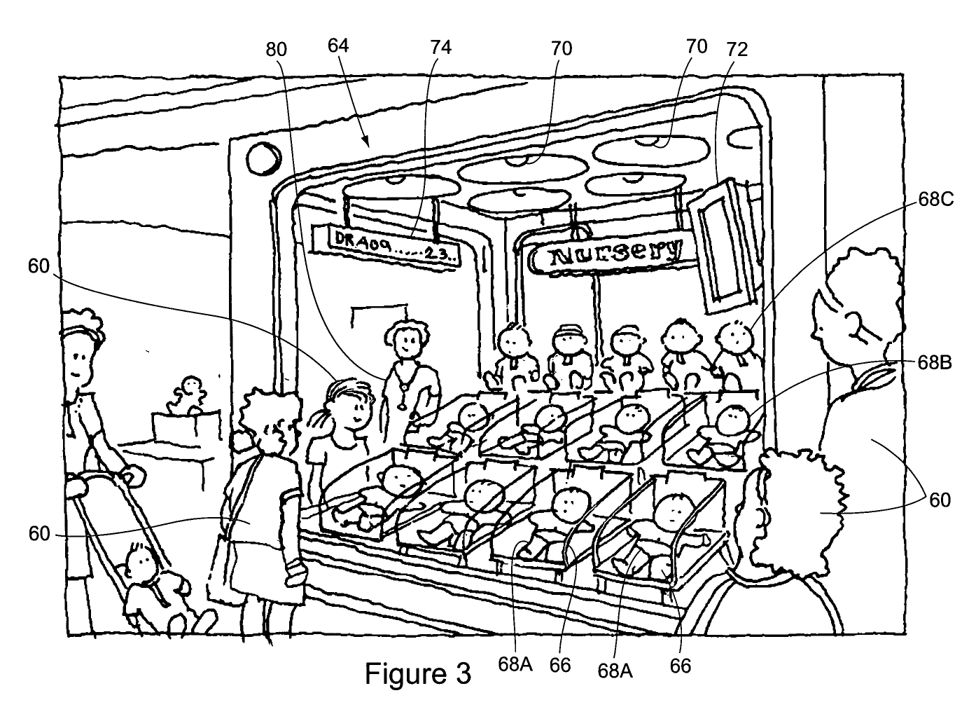

As noted above, the retail store environment 10 is at least partially configured to simulate a maternity hospital. This is an important aspect of the present invention, as it enhances the retail experience and provides customers, particularly children, with a sense of realism and heightens their emotional attachment to their new “baby.” As shown in FIG. 3, the experience preferably begins before entering the store, where customers 60 observe a store front 62, which presents an image as if looking into a modern, friendly, upscale maternity hospital, preferably including a simulated hospital nursery 64 that is visible, perhaps through glass, from outside the store. The simulated hospital nursery 64 attracts customers, builds anticipation, and invites children into the store. Because the target audience is children, the window and any railing is preferably low enough for small children to view the interior of the store. As shown in FIG. 3, the simulated nursery 64 preferably includes an array of incubators or isolettes 66 with a variety of dolls 68 clearly visible from outside the store. Dolls on display in the simulated nursery 64 are preferably representative of dolls available for sale on site. Preferably, the dolls displayed in the simulated nursery 64 are in various sizes, which, for example, may represent pre-term (or premature) babies 68A, full-term babies 68B, and older babies 68C (e.g., 6-months old). Also shown in FIG. 3, the simulated nursery 64 may include features, such as simulated heat lamps 70, computer/television monitors 72 that display custom images and/or advertising for merchandise available in the store, a doctors' call board 74, and pre-recorded sounds simulating those that may be heard in a busy hospital nursery, all of which add to the realism of the experience.

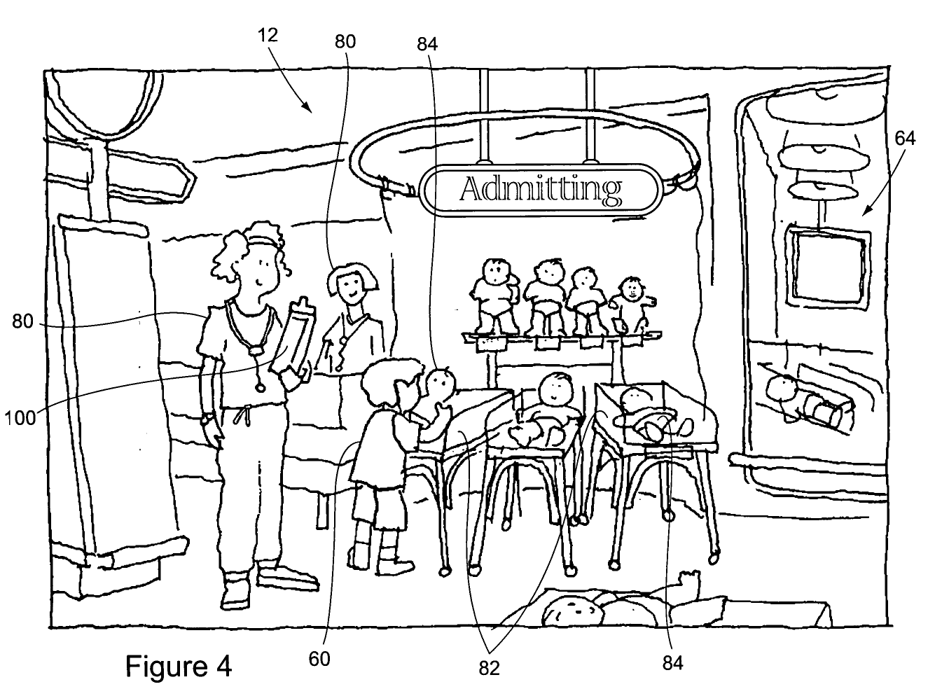

Preferably, the store 10 is adapted for staffing by one or more store representatives. More specifically, as shown in FIG. 4, upon entering the store 10, customers 60 are greeted by a store representative 80, which may be a store employee, who is preferably dressed as a nurse or other healthcare professional. Along with the rest of the store environment, having key store employees or other representatives pose as doctors, nurses or other healthcare professionals enhances the retail experience and provides young customers with a sense of realism. Preferably, this role of this employee 80 is more than a typical retail sales clerk, whose primary functions are merely to provide finished products to customers and process their purchases. In addition to these conventional functions, the employee 80 will preferably serve as the customer's guide through at least the initial stages of the interactive retail experience, educating and entertaining customers 60, perhaps with a scripted story that includes fictional components as well as factual information about the birthing process, baby care, parenting, etc. After greeting and providing the customer with at least general information about the process, the employee 80 preferably directs the customer to “Admitting” 12.

As illustrated in FIG. 4, the simulated Admitting area 12 may include features, such as customer accessible incubators or isolettes 82 with a sample dolls 84 that are representative of dolls available in inventory for sale to the customer 60. Preferably, these sample dolls 84, which can be picked up and held by customers, have a variety of different doll characteristics. As used herein, “doll characteristics” preferably includes characteristics that are also characteristics of real human babies, though they need not be. Such characteristics may include, but are not limited to, different sizes, body weights, genders, eye color, hair color, hair type, skin color. In addition, such features may include functional features, such as controlled movement of limbs, ability to drink, wet diapers, cry, etc. By observing and comparing the different doll characteristics exhibited by the sample dolls 84 displayed in the Admitting area 12, the customer can determine desired doll one or more characteristics. This is a departure from conventional “mass” retail environments, where dolls are usually packaged as “finished products” with little or no opportunity to test, compare and play with the dolls before purchasing them. In the simulated Admitting area 12, the customer 60 is preferably given an opportunity to fill out a simulated adoption application 100, perhaps with the assistance of a parent or employee 80. In addition to providing basic customer information on the application 100, the customer 60 can provide his or her “wishes” for one or more desired doll characteristics. Thus, the “admission” process allows for significant customer interaction, creativity, and enhances the bond the customer will have with his or her new doll, in stark contrast to the ways in which dolls have been conventionally sold at retail (e.g., “finished,” packaged, and stocked in mass on store shelves or in display cases with no opportunity to participate in the perceived “creation” of the doll in a realistic setting).

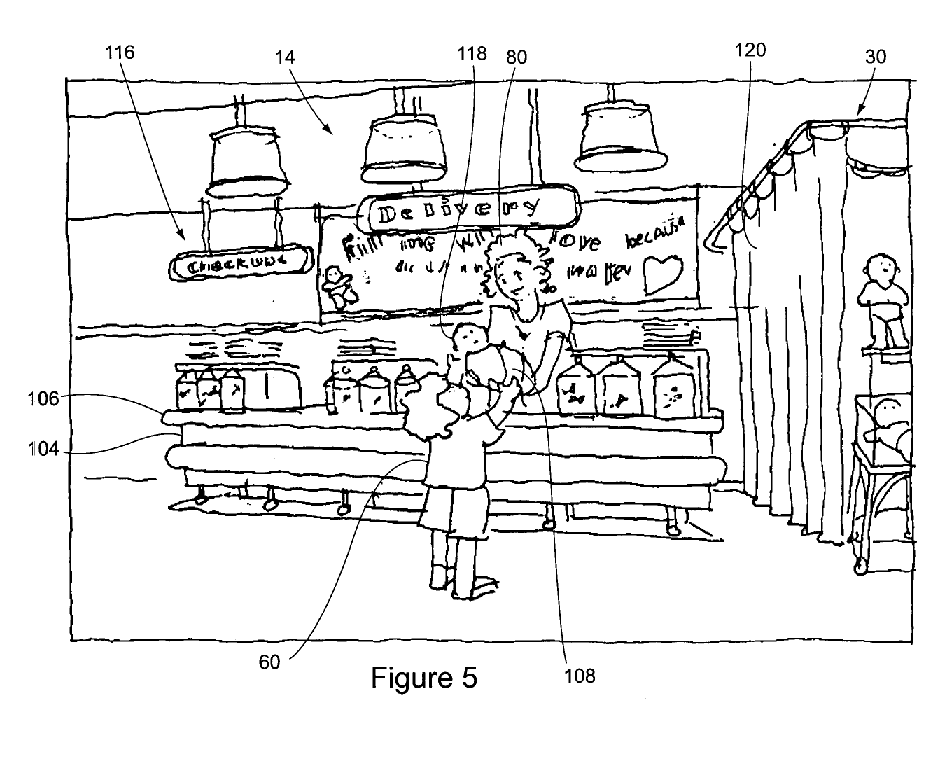

After the customer 60 has completed the adoption application 100, including the customer's “wishes” for desired doll characteristics, the employee 80 preferably directs the customer 60 to the simulated “Delivery” area 14, shown in FIG. 5. In the simulated Delivery area 14, a store employee 80 (which may be the same store employee that greeted the customer, or a different store employee) retrieves from the hidden inventory 30 a doll 118 having at least some of the customer's desired doll characteristics. Preferably, the inventory 30 of dolls is not visible from the Delivery area 14 or other areas of the retail store showroom, separated perhaps by an opaque partition, such as a curtain 120 resembling the kind of privacy curtain that may be found in a hospital room. Using a curtain 120 of this kind, rather than some other conventional means for partitioning the inventory 30 from the other areas of the retail showroom (e.g., a wall or door), is preferred because it contributes to the authenticity of the overall experience. Preferably, the methods of the present invention are practiced with dolls of the kind disclosed in U.S. Pat. No. 5,224,863; that is, dolls having a body constructed of flexible material defining an internal reservoir that is capable of being filled with a liquid medium, such as warm water. When filled, these dolls take on the feel, flexibility, and compressibility characteristics of a real infant baby. However, prior to filling, the “shells” are flat, flimsy and not very life-like. Therefore, preferably, the unfilled doll “shells” are stored in this hidden inventory 30, out of plain view from the showroom, to avoid detracting from the realism of the overall experience. Preferably, the inventor 30 is located reasonably proximate the Delivery area 16, for easy access by the employee 80. If hidden in this manner, it is possible to store the inventory of doll shells in an organized “shoe store” style manner, allowing for ready access to dolls having the customer's desired doll characteristics, without detracting from the authenticity of the overall experience.

Once the employee 80 has retrieved from the hidden inventory 30 a doll 118 having at least some of the customer's desired doll characteristics, the employee 80 preferably fills the doll 118, at least partially, with a fluid, and preferably a liquid, such as warm water, to simulate human body temperature (also preferably out of view of the customer, to avoid detracting from the realism of the overall experience) using methods and apparatus of the kind described in U.S. Pat. No. 5,224,863, though other methods and filling apparatus could be used in performing this step, without departing from the scope of the present invention, which is defined solely by the claims. In addition to filling the internal reservoir of the doll 118 with warm water, the employee 80 preferably wets at least part of an exterior surface of the doll's body with the water before handing the doll 118 to the customer 60 in a still wet condition, again to enhance the realism of the experience, which is intended to simulate receiving a baby that has just been born. Although the foregoing process of filling the doll 118 on site is preferred, because it provides a realistic experience, it should be understood that the step of at least partially filling the doll 118 with liquid may be performed on site by the customer or the customer's parent (“self service”) or off site, e.g., at home by the customer or the customer's parent, using filling apparatus of the kind disclosed in U.S. Pat. No. 5,224,863, or other suitable filling apparatus. It should also be noted that, although the preferred step of filling the doll 118 includes filling with a liquid, such as warm water, the doll 118 may also be filled with another fluid, such as air, without departing from the scope of the present invention as claimed. Because the doll “shells” are flexible, even air filling will cause the doll 118 to take on characteristics of a real infant baby, such as feel, flexibility, compressibility and heft. Air filling may even be preferable to liquid filling in instances where the customer wishes to simply purchase a “finished” doll for later use, e.g., as a gift.

The simulated Delivery area 14 shown in FIG. 5 is the area in which the customer first receives his or her own doll 118. Again, because target customers are children, the “Delivery” area 14 preferably includes a low counter 104 with soft countertops 106. At the same time, the customer 60 may receive a blanket 108 (which may be disposable or returnable) in which to hold the doll 118 and for drying the exterior surface of the doll. The customer 60 may also receive a hair bow (not shown), particularly if the doll is supposed to be female, and may choose the color. Additionally, shopping baskets and bassinets (not shown) may be made available for in-store use or for sale.

With continued reference to FIG. 5, the simulated Delivery area 14 may also include a “checkup” section 116, where the customer 60 and the employee 80 can perform a simulated “wellness check” of the newborn doll. Additionally, customers may return periodically for wellness checkups of their dolls (e.g., 3 months, 6 months and 9 months after “birth”, on birthdays, etc.). At such intervals, the employee 80 may further fill the doll 118 with additional liquid resulting in slight increases in weight and size, to simulate growth.

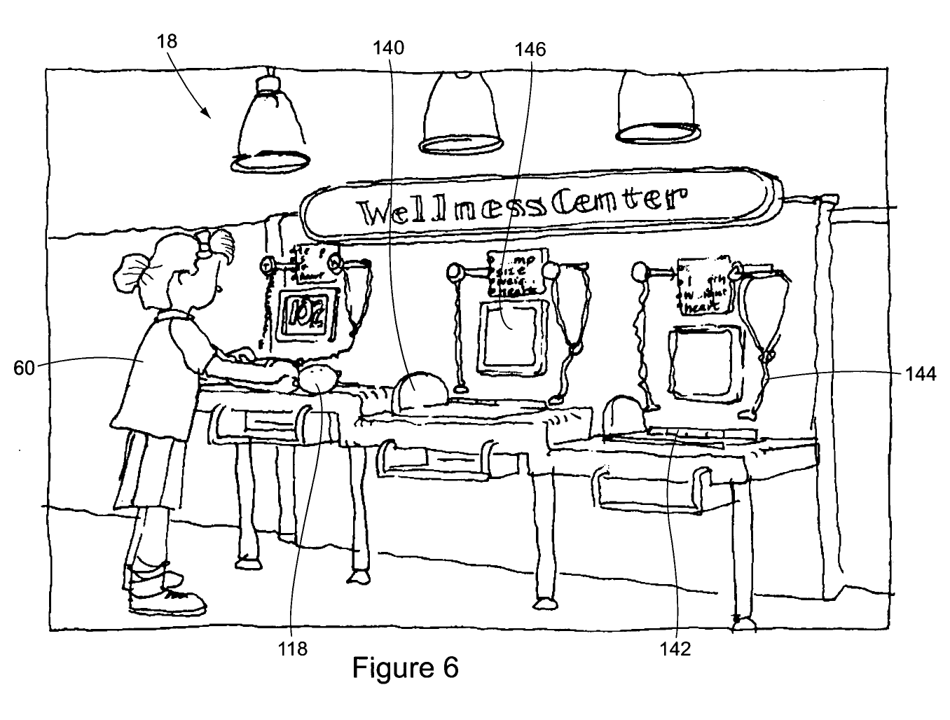

Following “delivery” of the doll 118 to the customer, the customer 60 is preferably directed to the “Wellness Center” 18, shown in FIG. 6, where the customer 60 is given an opportunity to conduct his or own simulated physical examination his or her new doll 118 using various examination apparatus and instruments. This Wellness Center may be in addition to, or in lieu of the checkup section 116 of the simulated Delivery area 14. As shown in FIG. 6, the Wellness Center may include, for example, scales 140, ruled measuring bars 142, thermometers (not shown), and stethoscopes 144. The scales 140 are preferably functional, but may be simulated without departing from the scope of the invention or the purpose of providing an interactive experience. Because the method of the present invention preferably utilizes liquid filled dolls, it is possible to vary the weight of the dolls by varying the amount of liquid contained therein. Also, preferably, dolls of various sizes and shapes are available, which allows for further opportunity for varied weights. Therefore, using functional scales 140 enhances the realism of the experience, because each customer's doll 118 may have a measurably different weight. The ruled measuring bars 142 are also preferably functional, allowing customers to measure the length of their dolls. As a practical matter, there may be less opportunity for measurably different lengths, if the doll shells are mass produced, though some variability will exist if dolls of different sizes and shapes are made available for selection by the customer. The thermometers (not shown) may be functional or simulated. Again, preferably, the dolls 118 are at least partially filled with warm water, which provides an opportunity for measurably different temperatures. If temperatures are carefully controlled during the filling process, it is possible to approximate normal human body temperature (i.e., 98.6 degrees Fahrenheit), as well as slightly elevated temperatures, to simulate a fever. Functional thermometers would allow customers to measure these temperatures, and perhaps monitor an elevated temperature until it returns to “normal,” again enhancing the realism of the overall experience. Alternatively, and particularly if it is not practical to carefully control temperatures during the filling process, the thermometers may be simulated, perhaps displaying a consistent 98.6 degrees Fahrenheit or a random temperature readout near 98.6 degrees Fahrenheit. The stethoscopes 144 are preferably simulated, as dolls of the kind described in U.S. Pat. No. 5,224,863 will not have a “heartbeat.” However, to enhancing the realism of the experience, a simulated heartbeat may be displayed when the customer uses a stethoscope 144 in the Wellness Center 18. Preferably, at least some of examination apparatus includes the capability or printing results or simulated results on paper or stickers, that customers 60 can take with them. Additionally, the results of the various exams can be digitally sent to the web nursery 42, as discussed hereinafter. As shown in FIG. 6, touch screens 146 may be provided for prompting the customer's actions and displaying data. Other examination apparatus and instruments could of course be provided to enhance the experience and allow for playful interactivity, without departing from the scope of the invention.

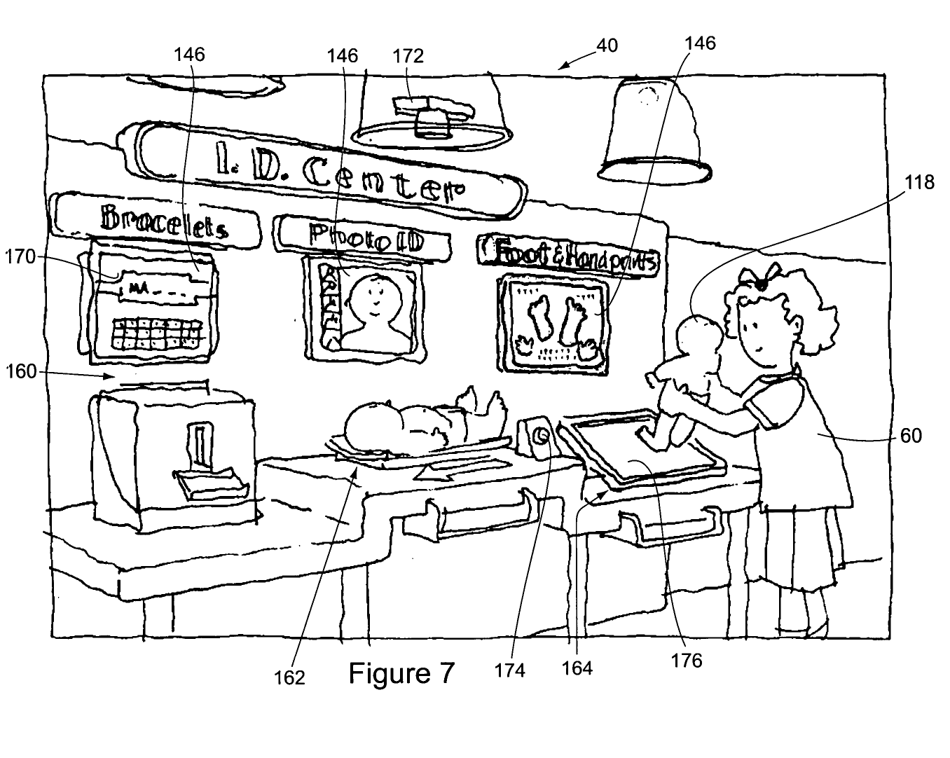

In the preferred embodiment of the invention described thus far, the customer 60 is preferably directed through the retail experience substantially in the order described above, beginning with a greeting, then on to Admitting 14, then to Delivery 16, and then to the Wellness Center 18, to generally simulate the order of events that occur in connection with real world baby deliveries at hospitals. Following these events, the customer may visit a variety of other sections 20 of the store 10, such as the identification center 40 (FIG. 7), web nursery 42, waiting room 44, playroom 46, and other various displays 54 showcasing merchandise available for sale. Although directing the customer in order through Admitting 14, Delivery 16 and the Wellness Center 18 is preferred because it generally simulates the order of corresponding real world events customers visiting the other sections of the store listed above may do so in any order.

As shown in FIG. 7, the identification center 40 preferably includes an identification bracelet station 160, a photo identification station 162 and a foot and hand print station 164. The identification bracelet station 160 preferably includes apparatus for producing pairs of matching identification bracelets 170, one being sized for the customer 60 and the other being sized for the doll 118, and bearing matching indicia. The bracelets 170 may be included in the purchase price of the doll 118, or made available for an additional charge. The photo identification station 162 preferably includes a camera 172 for taking a photograph of the customer's doll 118, a push button 174 operatively connected to the camera 172 for taking a photograph, and a printer (not shown) for printing the photograph on paper or a photo sticker. In addition, the photo may be sent digitally to the web nursery 42, as discussed hereinafter. The foot and hand print station 164 preferably includes a pad 176 against which the customer 60 can place the palms and feet of the doll 118 for making actual or simulated hand and foot prints. The pad may digitally record actual hand and foot prints, visible on touch screens 146 and/or digitally sent to a printer (not shown) or the web nursery 42, as discussed hereinafter.

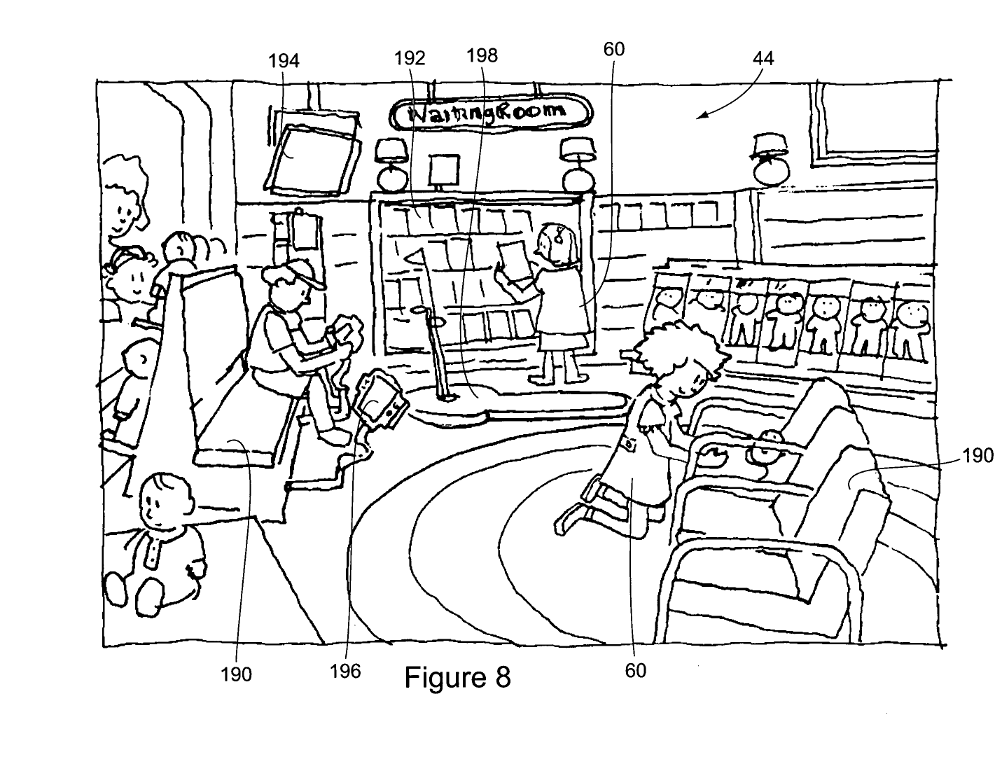

As shown in FIG. 8, the waiting room area 44 is preferably configured to simulate a hospital waiting room and is adapted for temporary occupation by customers 60 and persons accompanying customers. The waiting room area 44 may include seating 190 and activities, such as books 192, televisions 194, video games 196 and a putting green 198, for entertainment and to pass time while young customers shop and play.

The web nursery 42 (FIG. 2) preferably includes a plurality of computer stations 200 where customers can create, among other things, a personal “new baby” online web page, a gift registry (“wish list”), an official adoption or birth certificate, and birth announcements. Also at the web nursery 42, customers may access and print the results of their wellness checks performed at the Wellness Center 18, and their identification photographs and doll hand and foot prints recorded at the identification center 40. Additionally, customers may post these things on their “new baby” online web page or send them via e-mail to family and friends, all from the web nursery 42. Preferably, the web nursery 42 will also include information regarding “most popular” baby names, and may provide guidance to the customer 60 in name selection. As the intended users are children, the computer stations are preferably at a low level and include “kid sized” chairs. Kid-friendly touch screens may be provided in addition to or in lieu of other computer peripherals for data input.

As noted above, the retail store environment 10 preferably includes one or more of the following additional store areas or stations: a playroom 46, a family photo center 48, and various other displays 54 showcasing merchandise available for sale. The playroom 46 (FIG. 2) preferably provides space where customers can play and bond with their dolls, interact with others and compare dolls. Preferably, the playroom 46 is furnished and decorated to provide a cozy, home-like setting, and may serve as a “home base” between visits to the various activities and stations available in the store. The playroom 46 preferably includes doll clothes and other doll accessories available for play and fitting on customers' dolls, which encourages sales of such accessories. The opportunity to try and fit such clothing and accessories prior to purchase is again a departure from the conventional way in which dolls and doll accessories are sold in a mass retail environment. The family photo center 48 (FIG. 2) allows for photos of the doll, along with the customer, family and friends, and preferably includes a photo booth style camera station 202 that produces photos on paper or stickers. The camera station 202 may also send the photos digitally to the web nursery 42. The family photo center 48 allows for photos that are more personalized than the identification photos taken and the identification center 40, and may be available for an additional charge. Preferably, displays 54 showcase merchandise available for sale (e.g., doll clothing, doll furniture and other doll gear, “finished” dolls, seasonal products, etc.). While the dolls 118 are the focal point of the interactive retail experience, the concept lends itself to a wide range of baby-related accessories and products.

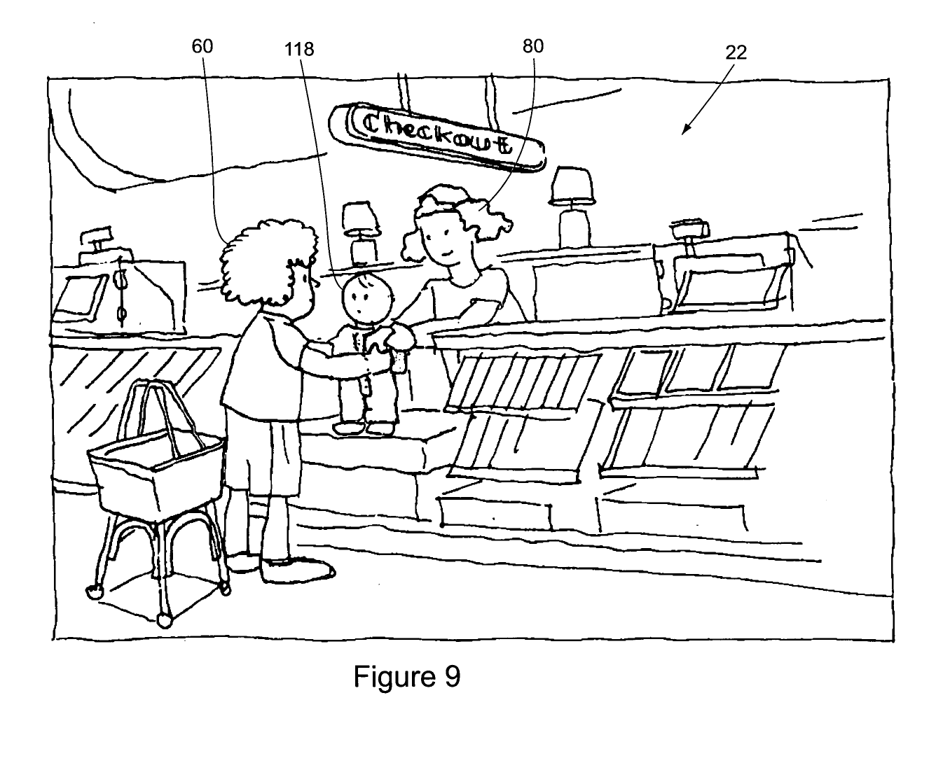

Finally, the customer 60 proceeds to the checkout area 22, as shown in FIG. 9, to purchase his or her doll 118, and any other merchandise, before leaving store. The check out area 22 preferably includes cash registers, credit card processing devices and other industry-standard purchase processing apparatus, as is well known in the art. Additionally, the check out area 22 preferably includes a print station where customers 60 and/or employees 80 can print customized “birth certificates” with general information about the customer and the doll (e.g., names, date, etc.) as well as information unique to the customer's specific doll 118, such as the doll's exact weight (e.g., as measured from the Wellness Center 18), and other unique characteristics of the doll. Upon check out, the customer 60 may be asked to pledge to be a good “parent” and a store employee (again, preferably dressed as a health care professional) may check identification bracelets worn by the customer 60 and his or her doll 118, for perceived security purposes.

The various sections of the retail store environment 10 that have been described above are preferably configured as distinctly identifiable sections, but are preferably interdependent and each form an integral part of the simulated maternity hospital environment, which adds to the customer's overall experience.

In view of the foregoing, it will be seen that the several advantages of the invention are achieved and attained. The embodiments were chosen and described in order to best explain the principles of the invention and its practical application to thereby enable others skilled in the art to best utilize the invention in various embodiments and with various modifications as are suited to the particular uses and purposes contemplated. However, as various modifications could be made in the invention described and illustrated without departing from the scope of the invention, it is intended that all matter contained in the foregoing description or shown in the accompanying Figures shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of retailing dolls comprising the steps of:
providing a retail store environment configured to simulate a maternity hospital with a simulated baby delivery area;
providing an on site inventory of dolls resembling human babies;
providing a retail store customer with an opportunity to select at least one desired doll characteristic; and
delivering to the customer a doll having said at least one desired doll characteristic, in the simulated baby delivery area.

2. The method of claim 1 wherein the step of delivering is performed by a retail store representative costumed as a health care professional.

3. The method of claim 1 wherein the doll delivered to the customer has a flexible body defining an interior volume, and wherein the method further comprises the step of at least partially filling the interior volume of the doll with a liquid.

4. The method of claim 3 wherein the step of at least partially filling the interior volume of the doll with a liquid is performed on site, proximate the simulated baby delivery area.

5. The method of claim 3 wherein the step of at least partially filling the interior volume of the doll with a liquid comprises at least partially filling the interior volume of the doll with a warm liquid.

6. The method of claim 3 wherein the step of at least partially filling the interior volume of the doll with a liquid is performed prior to the step of delivering the doll to the customer.

7. The method of claim 6 wherein the step of at least partially filling the interior volume of the doll with a liquid comprises wetting at least part of an exterior surface of the doll with the same or a different liquid, to simulate a wet condition of a newborn human baby, and wherein the step of delivering the doll to the customer includes presenting the doll to the customer while the part of the exterior surface of the doll is still wet.

8. The method of claim 1 wherein the simulated maternity hospital includes a section that is configured to simulate a post-delivery wellness center, the simulated post-delivery wellness center having apparatus adapted for measuring at least one of the length and weight of articles, and wherein the method further comprises the step of providing the customer with an opportunity to perform a simulated wellness check of the delivered doll, including an opportunity to measure at least one of the length and weight of the delivered doll.

9. The method of claim 1 wherein the simulated maternity hospital includes a section that is configured to simulate a post-delivery wellness center, the simulated post-delivery wellness center having apparatus configured to simulate a heart monitor, and wherein the method further comprises the step of providing the customer with an opportunity to perform a simulated wellness check of the delivered doll, including an opportunity to observe a simulated heartbeat of the delivered doll.

10. The method of claim 1 wherein the simulated maternity hospital includes a section that is configured to simulate a post-delivery wellness center, the simulated post-delivery wellness center having a thermometer, and wherein the method further comprises the step of providing the customer with an opportunity to measure the temperature of the delivered doll.

11. The method of claim 1 wherein the simulated maternity hospital further comprises an identification center having apparatus configured for marking identification devices with indicia, and wherein the method further comprises the step of providing the customer with a pair of such identification devices having matching indicia.

12. The method of claim 11 wherein the step of providing the customer with a pair of identification devices having matching indicia includes providing the customer with a pair of matching identification bracelets, one of the pair being sized to be worn by the customer and the other of the pair being sized to be worn by the delivered doll.

13. A method of retailing dolls comprising the steps of:
providing a retail store environment;
providing an on site inventory of dolls resembling human babies, each of said dolls having a body that at least partially defines an interior volume;
at least partially filling the interior volume of a selected one of said dolls with a fluid, on site proximate the retail store environment; and
delivering the selected doll to a customer on site.

14. The method of claim 13 wherein the step of at least partially filling the interior volume of the doll with a fluid comprises at least partially filling the interior volume of the doll with a warm liquid.

15. The method of claim 13 wherein the step of at least partially filling the interior volume of the doll with a fluid is performed prior to the step of delivering the doll to the customer.

16. The method of claim 13 wherein the step of at least partially filling the interior volume of the doll with a fluid comprises at least partially filling the interior volume of the doll with a liquid and wetting at least part of an exterior surface of the doll with the same or a different liquid, to simulate a wet condition of a newborn human baby, and wherein the step of delivering the doll to the customer includes presenting the doll to the customer while at least part of an exterior surface of the doll is still wet.

17. The method of claim 13 further comprising the step of providing the customer with an opportunity to select at least one desired doll characteristic, and wherein the doll delivered to the customer on site possesses said at least one desired doll characteristic.

18. The method of claim 13 wherein the step of providing a retail store environment includes providing an environment configured to simulate a maternity hospital with a simulated baby delivery area within the retail store environment, and wherein the step of delivering the selected doll to the customer is performed proximate the simulated baby delivery area.

19. The method of claim 18 wherein the step of delivering the selected doll to the customer is performed by a retail store representative costumed as a health care professional.

20. A retail store environment configured to simulate a maternity hospital, the retail store environment comprising:
an on site section of the retail store environment configured to simulate a hospital admitting area, including a display of information sufficient to allow a retail store customer to request a doll having at least one customer-selected doll characteristic;
an on site section of the retail store environment configured to simulate a baby delivery area, said simulated baby delivery area being adapted for staffing by a retail store representative who delivers to the customer a doll having said at least one customer-selected doll characteristic; and
a check-out center with retail equipment adapted for processing the sale of the delivered doll to the customer.

21. The retail store environment of claim 20 wherein the simulated hospital admitting area includes a display of representative samples of at least some of an inventory of dolls, at least some of said samples having a variety of different doll characteristics, whereby the customer can determine desired doll characteristics based on the representative samples displayed.

22. The retail store environment of claim 20 wherein the simulated hospital admitting area and simulated baby delivery area are located in distinct sections of the retail store environment.

23. The retail store environment of claim 20 further comprising an on site section of the retail store environment configured to simulate a post-delivery wellness center, the simulated post-delivery wellness center having physical examination apparatus available for use by the customer, said apparatus being configured to allow the customer to perform a physical examination of the delivered doll.

24. The retail store environment of claim 20 further comprising an identification center having apparatus configured for marking pairs of identification devices with matching indicia.

25. The retail store environment of claim 24 wherein the pairs of identification devices are paired identification bracelets, one of each pair being sized to be worn by a customer and the other of each pair being sized to be worn by the doll delivered to that customer.

26. A retail store environment configured to simulate a maternity hospital, the retail store environment comprising at least two store sections selected from a group consisting of:
a simulated hospital admitting area adapted to receive retail store customers and to display representative samples of dolls resembling human babies available for sale on site;
a simulated baby delivery area adapted to be staffed by a retail store representative who delivers dolls to customers;
a simulated post-delivery wellness center having physical examination apparatus adapted for performing physical examinations of dolls;
an identification center having apparatus for marking pairs of identification devices with matching indicia for matching customers with their dolls; and
a check-out center with retail transaction processing equipment adapted for processing sales of dolls to customers.

27. A method of retailing dolls comprising the steps of:
providing a retail store environment having an on site showroom configured to display merchandise, an on site inventory storage area configured for on site storage of an inventory of dolls resembling human babies, and an on site section configured to simulate a maternity hospital, the inventory of dolls in the inventory storage area being hidden from customer view;
displaying in the showroom representative samples of at least some of the inventory of dolls, said samples having a variety of doll characteristics that distinguish at least some of the samples from one another, whereby a customer viewing the display in the showroom can observe the distinguishing doll characteristics and determine at least one desired doll characteristic based on the representative samples displayed;
retrieving from the inventory storage area a doll having the at least one desired doll characteristic; and
delivering to the customer in the simulated maternity hospital a doll having said at least one desired doll characteristic.

28. The method of claim 27 wherein the step of delivering is performed by a retail store representative costumed as a health care professional.

29. The method of claim 27 wherein the doll delivered to the customer has a flexible body at least partially defining an interior volume, and wherein the method further comprises the step of at least partially filling the interior volume of the doll with a liquid.

30. The method of claim 29 wherein the step of at least partially filling the interior volume of the doll with a liquid comprises at least partially filling the interior volume of the doll with a warm liquid.

31. The method of claim 29 wherein the step of at least partially filling the interior volume of the doll with a liquid is performed on site by a retail store representative in an area of the retail store environment that is hidden from customer view.

32. The method of claim 29 wherein the step of at least partially filling the interior volume of the doll with a liquid is performed prior to the step of delivering the doll to the customer.

33. The method of claim 32 wherein the step of at least partially filling the interior volume of the doll with a liquid comprises wetting at least part of an exterior surface of the doll with the same or a different liquid, to simulate a wet condition of a newborn human baby, and wherein the step of delivering the doll to the customer includes presenting the doll to the customer while the part of the exterior surface of the doll is still wet.

34. The method of claim 1 wherein the step of providing a retail store customer with an opportunity to select at least one desired doll characteristic includes providing the customer with an opportunity to select a plurality of desired doll characteristics, and the step of delivering a doll to the customer includes delivering a doll at least some of said plurality of desired doll characteristics.
